(19) United States
(12) Patent Application Publication
(10) Pub. No.: US 2014/0315087 A1
(43) Pub. Date: Oct. 23, 2014

(54) POSITIVE ACTIVE MATERIAL, METHOD OF PREPARING THE SAME, AND RECHARGEABLE LITHIUM BATTERY INCLUDING THE SAME

(71) Applicant: SAMSUNG SDI CO., LTD., Yongin-si (KR)

(72) Inventors: Dong-Hwan YU, Yongin-si (KR); Young-Jin CHOI, Yongin-si (KR); Young-Soo JUNG, Yongin-si (KR); Ji-Yong LEE, Yongin-si (KR); Sung-Hoon KIM, Yongin-si (KR)

(73) Assignee: SAMSUNG SDI CO., LTD., Yongin-si (KR)

(21) Appl. No.: 14/071,807

(22) Filed: Nov. 5, 2013

(30) Foreign Application Priority Data
Apr. 23, 2013 (KR) 10-2013-0044947

(51) Int. Cl. H01M 4/36; H01M 4/04

(52) U.S. Cl. CPC H01M 4/366; H01M 4/049
USPC 429/221; 429/231.8; 429/231.1; 429/231.3; 429/224; 252/182.1; 427/105

(57) ABSTRACT

A method of preparing a positive active material for a rechargeable lithium battery includes dry-coating a surface of a material capable of doping and dedoping lithium with a carbon nanotube.

### CROSS-REFERENCE TO RELATED APPLICATION

Korean Patent Application No. 10-2013-0044947, filed on Apr. 23, 2013, in the Korean Intellectual Property Office, and entitled: “Positive Active Material and Method of Preparing Same, and Rechargeable Lithium Battery Including Positive Electrode Active Material,” is incorporated by reference herein in its entirety.

### BACKGROUND

1. Field

Embodiments are directed to a positive active material, a method of preparing the same, and a rechargeable lithium battery including the positive active material.

2. Description of the Related Art

Lithium rechargeable batteries have recently drawn attention as a power source for small portable electronic devices. The lithium rechargeable batteries use an organic electrolyte and thereby, have a discharge voltage that is twice or more as high as that of a conventional battery using an alkali aqueous solution. Accordingly, lithium rechargeable batteries have a high energy density.

Rechargeable lithium batteries include an electrolyte, a positive electrode including a positive active material that can intercalate and deintercalate lithium and a negative electrode including a negative active material that can intercalate and deintercalate lithium.

As for a positive active material for a lithium rechargeable battery, a lithium-transition metal oxides being capable of intercalating lithium, such as LiCoO₂, LiMn₂O₄, LiNi₁₋ₓCoₓO₂ (0<x<1), and the like, has been researched.

As for the negative active material for the lithium rechargeable battery, various carbon-based materials such as artificial graphite, natural graphite, and hard carbon capable of intercalating and deintercalating lithium ions have been used. Recently, a negative active material such as tin oxide, silicon oxide, vanadium oxide, and the like has been developed.

### SUMMARY

Embodiments are directed to a method of preparing a positive active material for a rechargeable lithium battery including dry-coating a surface of a material capable of doping and dedoping lithium with a carbon nanotube.

The dry-coating may be performed by introducing the material capable of doping and dedoping lithium and the carbon nanotube into a multipurpose mixer or a mechanofusion mixer and mixing the same.

The dry-coating may be performed for about 1 minute to about 30 minutes.

The dry-coating may be performed by mixing the carbon nanotube in an amount of about 0.1 parts by weight to about 5 parts by weight with 100 parts by weight of the material capable of doping and dedoping lithium.

The carbon nanotube may include a single-walled carbon nanotube, a double-walled carbon nanotube, a multi-walled carbon nanotube, a rope carbon nanotube, or a combination thereof.

The material capable of doping and dedoping lithium may include a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based oxide, or a combination thereof.

Embodiments are also directed to a positive active material for a rechargeable lithium battery prepared according to the method described above.

The positive active material may include the material capable of doping and dedoping lithium, and a coating layer including a carbon nanotube, the coating layer being formed continuously or discontinuously on a surface of the material capable of doping and dedoping lithium. An area where the coating layer is formed makes up about 60% to about 100% of an entire surface area of the material capable of doping and dedoping lithium.

The carbon nanotube may be included in an amount of about 0.1 parts to about 5 parts by weight based on 100 parts by weight of the material capable of doping and dedoping lithium.

The carbon nanotube may include a single-walled carbon nanotube, double-walled carbon nanotube, multi-walled carbon nanotube, rope carbon nanotube, or a combination thereof.

The material capable of doping and dedoping lithium may include a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based oxide, or a combination thereof.

Embodiments are also directed to a rechargeable lithium battery including the positive electrode including the positive active material described above, a negative electrode, and an electrolyte.

### BRIEF DESCRIPTION OF THE DRAWINGS

Features will become apparent to those of skill in the art by describing in detail exemplary embodiments with reference to the attached drawings in which:

FIG. 1 illustrates a schematic view showing a rechargeable lithium battery according to an embodiment.

FIG. 2 illustrates a scanning electron microscope image of the positive active material according to Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In one embodiment, a method of preparing a positive active material for a rechargeable lithium battery includes dry-coating a surface of a material capable of doping and dedoping lithium with a carbon nanotube (CNT).

Herein, the term “dry-coating” refers to a coating method without using a solution. In addition, ball milling dry-coating is not included.

The dry-coating may be performed, for example, by introducing the material capable of doping and dedoping lithium and the carbon nanotube into a multipurpose mixer or a mechanofusion mixer and mixing the same.

If a positive electrode were to be prepared by mixing a positive active material and a carbon nanotube utilizes a wet coating method of dispersing carbon nanotube in a solvent, and introducing/mixing a material capable of doping and dedoping lithium, and drying the same a large amount of carbon nanotube may be consumed during the manufacture process. In addition, a process of dispersing the carbon nanotube in a solution may be required, and a process of drying the mixed solution at a high temperature may be additionally required. Accordingly, the manufacturing processes may be complicated and time-consuming.

Furthermore, if a wet coating method were to be used, most of carbon nanotubes could become aggregated in a state of not adhering to the surface of material capable of doping and dedoping lithium, since the carbon nanotube has a high specific surface area. Accordingly, the wet coating method may be less desirable to provide a positive active material in which carbon nanotube is coated on the surface of material capable of doping and dedoping lithium.

In addition, a method of coating carbon nanotube according to a drying ball milling method may also require a large amount of carbon nanotube, and the method may be time-consuming so as to not be suitable for the mass production.

In a method of manufacturing a positive active material according to an embodiment, a continuous or discontinuous carbon nanotube coating layer is formed on a surface of the material capable of doping and dedoping lithium through dry-coating.

The area where the coating layer is formed may be about 60% to about 100% of the entire surface area of the material capable of doping and dedoping lithium. As examples, the area where the coating layer is formed may be about 60% to about 95% and more desirably, about 70% to about 85% of the entire surface area of the material capable of doping and dedoping lithium.

The carbon nanotube may be very uniformly coated on the surface of material capable of doping and dedoping lithium. Accordingly, the positive active material obtained from the preparation may exhibit remarkably decreased resistance against a current collector and improved adherence.

In addition, if adding a small amount of conductive material into the positive electrode, or even if not additionally using the conductive material, the electrical conductivity may be sufficient, so the energy density of positive active material may be enhanced.

As a result, the battery including the positive active material may have improved high-capacity characteristics, high power characteristics, high-rate characteristics, and cycle-life characteristics or the like which are desirable for a high-power battery.

The time for the dry-coating may be about 1 minute to about 30 minutes. Instead of requiring a prolonged time, the manufacturing method according to the present embodiment may allow the coating to be completed within about 30 minutes, so the manufacturing time may be remarkably shortened. According to the manufacturing method, sufficient coating effects may be obtained even if coating is carried out within a very short time.

In addition, an additional process for dispersing carbon nanotube is not required, and a process of drying at a high temperature is also not required, so the manufacturing process may be very simple and the manufacturing efficiency may be enhanced.

In the manufacturing method according to the present embodiment, the carbon nanotube may be used in an amount of about 0.1 parts by weight to about 5 parts by weight, or, for example, about 0.1 parts by weight to about 4 parts by weight or about 0.1 parts by weight to about 3 parts by weight based on 100 parts by weight of the material capable of doping and dedoping lithium. The amount of carbon nanotube is remarkably reduced compared to the amount used in a wet coating or ball milling manufacturing method. Accordingly, economical advantages may be expected. According to the manufacturing method, the coating effects are sufficient even if a small amount of carbon nanotube, such as less than or equal to about 5 parts by weight, is used.

The carbon nanotube may include any suitable carbon nanotube. For example the carbon nanotube may be a single-walled carbon nanotube (SWCNT), a double-walled carbon nanotube (DWCNT), a multi-walled Carbon nanotube (MWCNT), a rope carbon nanotube, or a combination thereof.

The material capable of doping and dedoping lithium may be any material capable of performing an oxidation reduction reaction of a lithium ion. For example, the material capable of doping and dedoping lithium may be a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based oxide, or a combination thereof.

A composite oxide of a metal of cobalt, manganese, nickel, or a combination thereof, and lithium may be used. Specific examples include the compounds represented by the following chemical formulae. LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The compounds may have a coating layer on the surface, or may be mixed with another compound having a coating layer. The coating layer may include an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound. For example, the method may include any coating method such as spray coating, dipping, or the like.

In another embodiment, a positive active material for a rechargeable lithium battery includes a material capable of doping and dedoping lithium, and a coating layer including a carbon nanotube and being formed continuously or discontinuously on a surface of the material capable of doping and dedoping lithium.

The area where the coating layer is formed may be about 60% to about 100% of the entire surface area of the material capable of doping and dedoping lithium. In one embodiment, the area where the coating layer is formed may be about 60% to about 95%, and in another embodiment, the area whee the coating layer is formed may be about 70% to about 85%. The carbon nanotube may be very uniformly coated on the surface of material capable of doping and dedoping lithium.

The positive active material may have remarkably low resistance against a current collector and excellent adherence. The battery including the same may accomplish high-capacity, high power, high-rate, and high cycle-life characteristics.

The carbon nanotube may be included in an amount of about 0.1 parts by weight to about 5 parts by weight based on 100 parts by weight of the material capable of doping and dedoping lithium. For example, the carbon nanotube may be included in an amount of about 0.1 parts by weight to about 4 parts by weight or about 0.1 parts by weight to about 3 parts by weight based on 100 parts by weight of the material capable of doping and dedoping lithium. Thereby, the positive active material may have a remarkably low resistance against the current collector and may provide excellent battery performance.

The carbon nanotube is the same as described above.

The material capable of doping and dedoping lithium is the same as described above and thus description thereof is not repeated.

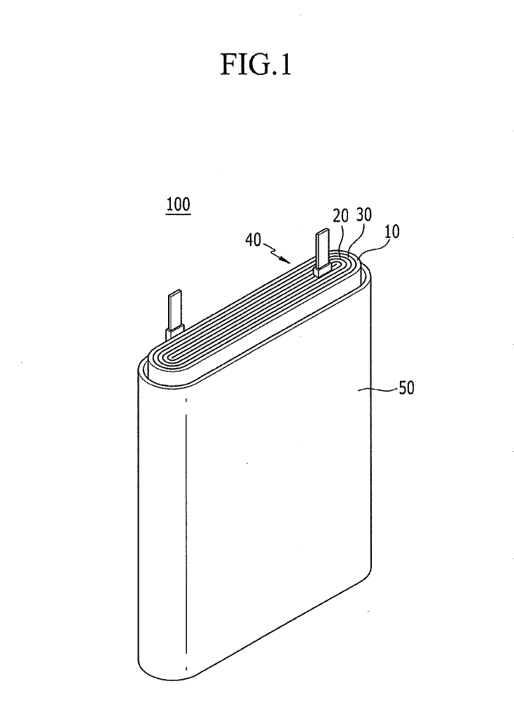

In another embodiment, a rechargeable lithium battery includes the positive electrode including a positive active material, a negative electrode, and an electrolyte. A rechargeable lithium battery according to one embodiment is described referring to FIG. 1. FIG. 1 illustrates a schematic view showing a rechargeable lithium battery according to an embodiment.

Referring to FIG. 1, a rechargeable lithium battery 100 according to the present embodiment includes an electrode assembly 40 manufactured by winding a separator 30 interposed between a positive electrode 10 and a negative electrode 20 and a case 50 housing the electrode assembly 40. An electrolyte (not shown) may be impregnated in the positive electrode 10, the negative electrode 20, and the separator 30.

The positive electrode 10 includes a current collector and a positive active material layer formed on the current collector, and the positive active material layer includes a positive active material.

The positive active material is the same as described above.

The current collector may be Al as an example.

The positive active material layer may further include a binder. The binder may bind positive active material particles to each other and to a current collector.

Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The positive active material layer may further include a conductive material. The conductive material may improve electrical conductivity of the negative electrode 20. Any electrically conductive material that does not cause a chemical change may be used. Examples of the conductive material include one or more of natural graphite, artificial graphite, carbon black, acetylene black, ketjen black, a carbon fiber, a metal powder or a metal fiber of copper, nickel, aluminum, silver, or the like, a polyphenylene derivative, or the like.

The positive active material according to one embodiment includes a coating layer including a carbon nanotube on the surface. Accordingly, sufficient electrical conductivity may be realized even though a small amount of a conductive material is used or a conductive material is not used in the positive electrode 10.

The negative electrode 20 includes a current collector and a negative active material layer formed on the current collector, and the negative active material layer includes a negative active material.

The negative active material may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may be a carbon material, and may be any generally-used carbon-based negative active material in a rechargeable lithium ion battery. Examples thereof include crystalline carbon, amorphous carbon, or a combination thereof. The crystalline carbon may be non-shaped or sheet, flake, spherical, or fiber shaped natural graphite or artificial graphite. The amorphous carbon may be a soft carbon, a hard carbon, a mesophase pitch carbonized product, fired coke, or the like.

The lithium metal alloy include lithium and a metal of Na, K, Rb, Cs, Fr, Be, Mg, Ca, Sr, Si, Sb, Pb, In, Zn, Ba, Ra, Ge, Al, or Sn.

The material capable of doping and dedoping lithium may include Si, SiOₓ (0<x<2), a Si—C composite, a Si-Q alloy (wherein Q is an alkali metal, an alkaline-earth metal, Group 13 to 16 elements, a transition metal, a rare earth element, or a combination thereof, and is not Si), Sn, SnO₂, a Sn—C composite, a Sn—R alloy (wherein R is an alkali metal, an alkaline-earth metal, Group 13 to 16 elements, a transition metal, a rare earth element, or a combination thereof, and is not Sn), or the like. Specific elements for Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, or the like.

The negative active material layer may include a binder, and may further include a conductive material.

The binder may bind negative active material particles to each other and to a current collector. Examples of the binder may include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, as examples.

The conductive material may improve the electrical conductivity of the negative electrode 20. Any electrically conductive material that does not cause a chemical change may be used. Examples of the conductive material include a carbon-based material such as natural graphite, artificial graphite, carbon black, acetylene black, ketjen black, a carbon fiber, or the like; a metal-based material such as a metal powder or a metal fiber of copper, nickel, aluminum, silver, or the like; a conductive polymer such as a polyphenylene derivative; or a mixture thereof.

The current collector may be a copper foil, a nickel foil, a stainless steel foil, a titanium foil, a nickel foam, a copper foam, a polymer substrate coated with a conductive metal, or a combination thereof.

The electrolyte may include a non-aqueous organic solvent and a lithium salt.

The non-aqueous organic solvent may play a role of transferring ions taking part in the electrochemical reaction of a battery.

The non-aqueous organic solvent may include a carbonate-based, ester-based, ether-based, ketone-based, alcohol-based, or aprotic solvent. The carbonate based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, or the like. The ether-based solvent may be, for example dibutylether, tetraglyme, diglyme, dimethoxyethane, 2-methyltetrahydrofuran, tetrahydrofuran, or the like. The ketone based solvent may be cyclohexanone, or the like. The alcohol-based solvent may be ethanol, isopropyl alcohol, or the like. The aprotic solvent include a nitrile such as R—CN (wherein R is a C2 to C20 linear, branched, or cyclic hydrocarbon group, and may include one or more double bonds, one or more aromatic rings, or one or more ether bonds), an amide such as dimethylformamide or dimethylacetamide, a dioxolane such as 1,3-dioxolane, a sulfolane, or the like.

The non-aqueous organic solvent may be used singularly or in a mixture. When the organic solvent is used in a mixture, the mixture ratio may be controlled in accordance with a desirable performance of the battery.

The carbonate-based solvent may include a mixture of a cyclic carbonate and a linear carbonate. When the cyclic carbonate and the linear carbonate are mixed together in a volume ratio of about 1:1 to about 1:9 in the electrolyte, the electrolyte may have enhanced performance.

The non-aqueous organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The non-aqueous electrolyte may further include vinylene carbonate or an ethylene carbonate-based compound in order to improve the cycle-life of the battery.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, vinylene ethylene carbonate, or the like. When the vinylene carbonate or the ethylene carbonate-based compound is further used, the amounts thereof may be appropriately adjusted for improving the cycle-life.

The lithium salt is dissolved in the non-aqueous organic solvent, supplies a battery with lithium ions, basically operates the rechargeable lithium battery, and improves transportation of the lithium ions between the positive electrode 10 and the negative electrode 20. Examples of the lithium salt include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bis(oxalato)borate; LiBOB), or a combination thereof, which is used as a supporting electrolytic salt. The lithium salt may be used in a concentration ranging from about 0.1 M to about 2.0 M. When the lithium salt is included at the above concentration range, an electrolyte may have optimal electrolyte conductivity and viscosity, and may thus have enhanced performance and effective lithium ion mobility.

The separator 30 may include any suitable materials used to separate a negative electrode from a positive electrode and to provide a transporting passage for lithium ions. The separator 30 may be made of a material having a low resistance to ion transportation and an improved impregnation for an electrolyte. For example, the material may be selected from a glass fiber, polyester, TEFLON (tetrafluoroethylene), polyethylene, polypropylene, polytetrafluoroethylene (PTFE), or a combination thereof. The separator 30 may have a form of a non-woven fabric or a woven fabric. For example, a polyolefin-based polymer separator such as polyethylene, polypropylene or the like may be used for a lithium ion battery. In order to ensure the heat resistance or mechanical strength, a coated separator including a ceramic component or a polymer material may be used. As examples, the separator 30 may have a mono-layered or multi-layered structure.

The following Examples and Comparative Examples are provided in order to highlight characteristics of one or more embodiments. It is to be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### Manufacture of Positive Active Material

100 parts by weight of LiNi_{0.6}CO_{0.2}Mn_{0.2}O₂ and 3 parts by weight of carbon nanotube (multi-walled carbon nanotube: MWCNT) were introduced into a multipurpose mixer and mixed for 10 minutes to 15 minutes, to prepare a positive active material of a carbon nanotube coating layer discontinuously formed on LiNi_{0.6}CO_{0.2}Mn_{0.2}O₂. The area where the coating layer was formed was 80% of the entire surface area of LiNi_{0.6}CO_{0.2}Mn_{0.2}O₂.

Manufacture of Rechargeable Lithium Battery Cell

(Positive Electrode)

95 wt % of the obtained positive active material and 5 wt % of polyvinylidene fluoride (PVdF) binder were mixed and added with an N-methylpyrrolidone (NMP) solvent to provide a positive active material slurry. The obtained positive active material slurry was coated onto an aluminum foil, dried, and roll-pressed, to provide a positive electrode.

(Negative Electrode)

95 wt % of natural graphite as a negative active material and 5 wt % of polyvinylidene fluoride as a binder were mixed to provide a negative active material slurry. The obtained negative electrode slurry was coated onto a copper foil, dried, and roll-pressed, to provide a negative electrode.

(Battery Cell Assembly)

The obtained positive electrode and negative electrode, and a polyethylene separator were used and were injected with an electrolyte (1 mole of lithium hexafluorophosphate (LiPF₆), ethylene carbonate (EC)/ethylmethylcarbonate (EMC)=1/2 volume ratio) to provide a prismatic cell.

### Example 2

A positive active material and a rechargeable lithium battery cell were manufactured in accordance with the same procedure as in Example 1, except that 2 parts by weight of carbon nanotube was used. The positive active material was a carbon nanotube coating layer discontinuously formed on LiNi_{0.6}Co_{0.2}Mn_{0.2}O₂. The area where the coating layer was formed was 70% of the entire surface area of LiNi_{0.6}Co_{0.2}Mn_{0.2}O₂.

### Example 3

A positive active material and a rechargeable lithium battery cell were manufactured in accordance with the same procedure as in Example 1, except that 1 part by weight of a carbon nanotube was used. The positive active material was a carbon nanotube coating layer discontinuously formed on LiNi_{0.6}Co_{0.2}Mn_{0.2}O₂. The area where the coating layer was formed was 60% of the entire surface area of LiNi_{0.6}Co_{0.2}Mn_{0.2}O₂.

### Comparative Example 1

90 wt % of the positive active material for a rechargeable lithium battery, a conductive material of 5 wt % of graphite and a binder of 5 wt % of polyvinylidene fluoride (PVdF) were mixed and dispersed in N-methyl-2-pyrrolidone to provide a positive active material slurry. The slurry was uniformly coated onto an aluminum foil, dried and compressed by a press to provide a positive electrode.

The other processes were the same as in Example 1 to provide a rechargeable lithium battery cell.

### Evaluation Example 1

### Scanning Electron Microscope (FE-SEM)

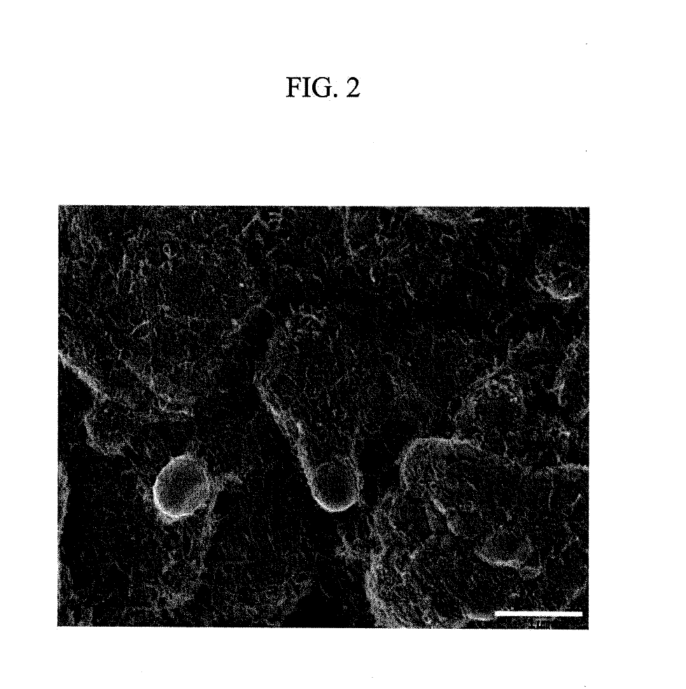

An image of the positive active material obtained from Example 2 was obtained by a scanning electron microscope. The image is illustrated in FIG. 2. Referring to FIG. 2, it may be confirmed that carbon nanotubes were uniformly coated on the surface of positive active material.

### Evaluation Example 2

### Electrode Resistance and Charge and Discharge Characteristics of Battery Cell

Each obtained rechargeable lithium battery cell was measured for electrode resistance and charge and discharge characteristics. The results are shown in the following Table 1.

The charge and discharge cut-off voltage was set in 4.2-3.0 V, and the charge and discharge was determined by measuring the efficiency relative to the initial capacity (0.2 C) after performing under the constant current mode at 10 C, and 20 C, respectively.

TABLE 1

| | | Specific | Capacity | Capacity | |
|---|---|---|---|---|---|
| | CNT coating | resistance of | Efficiency | Efficiency | |
| | amount (wt %) | electrode (Ω · m) | (10 C/0.2 C) | (20 C/0.2 C) | Note |
| Comparative | 0 | 5.2 | 85% | 73% | Conductive |
| Example 1 | | | | | material: 5 wt % |
| Example 3 | 1.0 | 5.8 | 86% | 75% | Additional |
| | | | | | conductive |
| | | | | | material: X |
| Example 2 | 2.0 | 3.0 | 90% | 77% | Additional |
| | | | | | conductive |
| | | | | | material: X |
| Example 1 | 3.0 | 1.2 | 96% | 89% | Additional |
| | | | | | conductive |
| | | | | | material: X |

Referring to Table 2, it can be seen that the specific resistance of electrode according to Examples was decreased compared to Comparative Examples, and the capacity efficiency was significantly improved at 10 C and 20 C.

By way of summation and review, the developments of high power, high-capacity batteries have remarkably increased recently. In order to improve the high power characteristics of batteries, a decrease of electrode resistance is desirable. In particular, it is desirable to decrease the electrode resistance of batteries and to provide excellent characteristics such as high power, high-capacity, high-rate and high cycle-life.

Embodiments provide a positive active material having low resistance with respect to an electrode, a high energy density, and improved high-capacity characteristics, high power characteristics, high-rate characteristics, and cycle-life characteristics. Embodiments provide a method of manufacturing the same and a rechargeable lithium battery including the positive active material. A rechargeable lithium battery including the positive active material has improved high-capacity characteristics, high power characteristics, high-rate characteristics, and cycle-life characteristics

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A method of preparing a positive active material for a rechargeable lithium battery, the method comprising:
dry-coating a surface of a material capable of doping and dedoping lithium with a carbon nanotube.

2. The method as claimed in claim 1, wherein the dry-coating is performed by introducing the material capable of doping and dedoping lithium and the carbon nanotube into a multipurpose mixer or a mechanofusion mixer and mixing the same.

3. The method as claimed in claim 1, wherein the dry-coating is performed for about 1 minute to about 30 minutes.

4. The method as claimed in claim 1, wherein the dry-coating is performed by mixing the carbon nanotube in an amount of about 0.1 parts by weight to about 5 parts by weight with 100 parts by weight of the material capable of doping and dedoping lithium.

5. The method as claimed in claim 1, wherein the carbon nanotube includes a single-walled carbon nanotube, a double-walled carbon nanotube, a multi-walled carbon nanotube, a rope carbon nanotube, or a combination thereof.

6. The method as claimed in claim 1, wherein the material capable of doping and dedoping lithium includes a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based oxide, or a combination thereof.

7. A positive active material for a rechargeable lithium battery prepared according to the method as claimed in claim 1.

8. The positive active material as claimed in claim 7, wherein:
the positive active material includes the material capable of doping and dedoping lithium, and a coating layer including a carbon nanotube, the coating layer being formed continuously or discontinuously on a surface of the material capable of doping and dedoping lithium, and
an area where the coating layer is formed makes up about 60% to about 100% of an entire surface area of the material capable of doping and dedoping lithium.

9. The positive active material as claimed in claim 7, wherein the carbon nanotube is included in an amount of about 0.1 parts to about 5 parts by weight based on 100 parts by weight of the material capable of doping and dedoping lithium.

10. The positive active material as claimed in claim 7, wherein the carbon nanotube includes a single-walled carbon nanotube, double-walled carbon nanotube, multi-walled carbon nanotube, rope carbon nanotube, or a combination thereof.

11. The positive active material of claim 7, wherein the material capable of doping and dedoping lithium includes a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based oxide, or a combination thereof.

12. A rechargeable lithium battery, comprising
a positive electrode including the positive active material according to claim 7,
a negative electrode, and
an electrolyte.
